(19) United States
(12) Patent Application Publication
(10) Pub. No.: US 2016/0233021 A1
(43) Pub. Date: Aug. 11, 2016

(54) BOBBIN, TRANSFORMER AND METHOD FOR WINDING A WIRE AROUND THE BOBBIN

(71) Applicant: Delta Electronics (Jiangsu) CO., LTD, Wujiang City (CN)

(72) Inventors: Jiayou MA, Wujiang City (CN); Shaodong ZHANG, Wujiang City (CN)

(21) Appl. No.: 14/956,510

(22) Filed: Dec. 2, 2015

(30) Foreign Application Priority Data
Feb. 11, 2015 (CN) 201510072912.4

(51) Int. Cl. H01F 27/32; H01F 41/10; H01F 27/29; H01F 41/06; H01F 27/24; H01F 27/28

(52) U.S. Cl. CPC H01F 27/325; H01F 27/24; H01F 27/2823; H01F 27/2828; H01F 27/29; H01F 41/0612; H01F 41/10

(57) ABSTRACT

The embodiments of the present disclosure relate to a bobbin, a transformer, and a method for winding a wire around a bobbin. The bobbin comprises a main body for winding a wire thereon; a first baffle plate and a second baffle plate respectively disposed on both ends of the main body; a plurality of conduction pins provided on the second baffle plate; and an auxiliary wire winding portion comprising at least one wire winding pin for electrically connecting with at least one of the plurality of conduction pins.

### CROSS REFERENCE TO RELATED APPLICATIONS

This application claims the priority to and the benefit of the Chinese patent application No. 201510072912.4, filed on Feb. 11, 2015, and entitled “bobbin, transformer, and method for winding a wire around the bobbin”, which is incorporated herein by reference in its entirety.

### TECHNICAL FIELD

The present disclosure relates to a bobbin, a transformer, and a method for winding a wire around the bobbin, particularly, relates to a bobbin having a wire winding pin for electrically connecting to a conduction pin, a bobbin, and a method for winding a wire around a bobbin.

### BACKGROUND

A bobbin is generally used for winding a wire thereon so as to form a transformer. A conventional bobbin comprises a main body, a first baffle plate, a second baffle plate and conduction pins. The first baffle plate and the second baffle plate are respectively disposed at two ends of the main body. The wire is wound around the main body and the conduction pin so as to form a plurality of windings (not shown). The conventional bobbin generally has 4 conduction pins. The wire is wound around the main body and the conduction pins by manual work or a winding machine, such that the function of each conduction pin could be realized. With increasing demands on the function of the transformer, a technical solution of increasing the number of conduction pins is raised. For example, the number of conduction pins is designed to be 5 or 6, and each conduction pin can be electrically connected to a circuit board so as to play an electrically function. However, with the increased number of the conduction pins, winding process becomes much more complicated. Consequently, the connection between each conduction pin and the wire can be only achieved by manual work rather than automation, which leads to high costs, and unstable quality.

The foresaid information as disclosed in the background art only serves to enhance understanding of the background of the disclosure, thereby it may contains information not to constitute the prior art as known by those skilled in the art.

### SUMMARY

In order to overcome at least one deficiency of the prior art, an object of the disclosure is to provide a bobbin, a transformer, and a method for winding a wire around the bobbin to achieve fast winding, and meets the demands of increasing the number of the conduction pins.

Additional aspects and advantages of the disclosure will in part set forth in the description below, and in part will become obvious from the description, or may be learned from practice of the present disclosure.

In one aspect, the present disclosure provides a bobbin, comprising:

a main body for winding a wire thereon;

a first baffle plate and a second baffle plate respectively disposed on both ends of the main body;

a plurality of conduction pins provided on the second baffle plate; and

an auxiliary wire winding portion comprising at least one wire winding pin for electrically connecting with at least one of the plurality of conduction pins.

In another aspect, the present disclosure provides a transformer, comprising: a bobbin;

a magnetic core; and

a winding portion comprising at least one first winding and at least one second winding;

wherein the bobbin comprising:

a main body for winding the winding portion thereon;

a first baffle plate and a second baffle plate respectively disposed on both ends of the main body;

a plurality of conduction pins provided on the second baffle plate; and

an auxiliary wire winding portion comprising at least one wire winding pin for electrically connecting with at least one of the plurality of conduction pins.

In another aspect, the present disclosure provides a method for winding a wire around a bobbin, comprising:

providing a bobbin having a main body, an auxiliary wire winding portion and a plurality of conduction pins, the auxiliary wire winding portion comprising at least one wire winding pin;

winding a wire around the main body to form a first winding;

electrically connecting one end of the first winding with at least one wire winding pin;

winding a wire around the main body to form a second winding; and

electrically connecting one end of the second winding with the at least one wire winding pin so as to electrically connect said end of the second winding with said end of the first winding member.

The foregoing summary is not intended to summarize each potential embodiment or every aspect of the present disclosure.

### BRIEF DESCRIPTION OF THE DRAWINGS

The above and other features and advantages of the present disclosure will become more apparent from the detailed description of exemplary embodiments thereof with reference to accompany drawings.

FIG. 1 is a front schematic view of the bobbin according to the first embodiment of the disclosure.

FIG. 2 is a side schematic view of the bobbin according to the first embodiment of the disclosure.

FIG. 3 is a top schematic view of the bobbin according to the first embodiment of the disclosure.

FIG. 4 is a bottom schematic view of the bobbin according to the first embodiment of the disclosure.

FIG. 5 is a perspective schematic view of the bobbin according to the first embodiment of the disclosure.

FIG. 6 is a schematic view as a result of winding wires around the bobbin according to the first embodiment of the disclosure.

FIG. 7 is a bottom schematic view of the bobbin according to the second embodiment of the disclosure, which shows 6 conduction pins.

FIG. 8 is a schematic view as a result of winding wires around the bobbin according to the second embodiment of the disclosure.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Hereinafter, implementations of methods and apparatuses for processing short messages according to the embodiments of the present disclosure will be described in detail in conjunction with the drawings.

### First Embodiment of a Bobbin

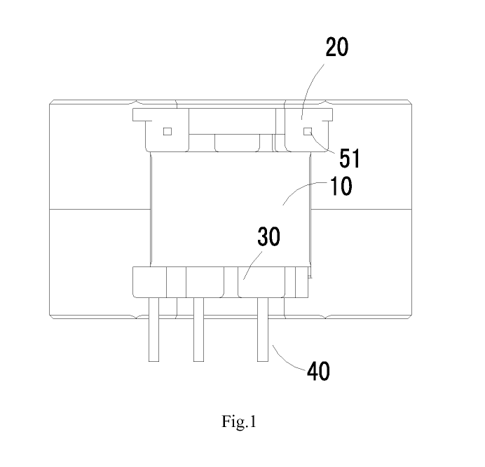

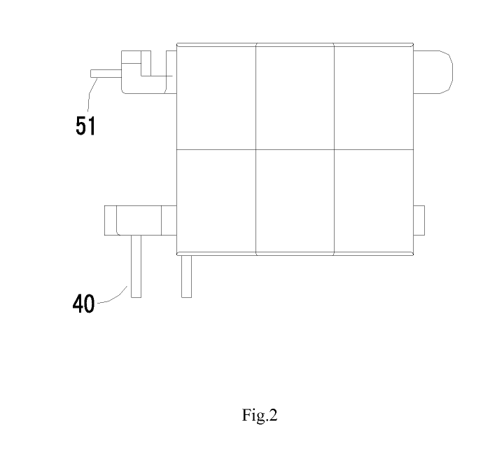

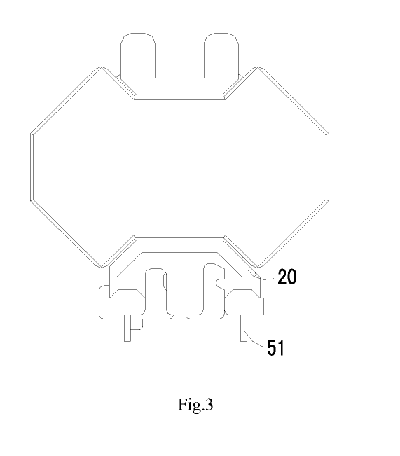

With reference to FIGS. 1-5, the present embodiment provides a bobbin comprising a main body 10, a first baffle plate 20, a second baffle plate 30, a plurality of conduction pins 40, and an auxiliary wire winding portion 50. The main body 10 extends along an axis and used to wind a wire (not shown) thereon. The first baffle plate 20 and the second baffle plate 30 are disposed on both ends of the main body 10 respectively. The plurality of conduction pins 40 are disposed on the second baffle plate 30. The auxiliary wire winding portion 50 is disposed on the first baffle plate 20 and comprise at least one wire winding pin 51 connected to the first baffle plate 20. At least a part of the wire winding pin 51 is conductive and electrically connected to the conduction pin 40 via a wire. The present disclosure is not limited thereto, for example, the wire winding pin 51 can also be disposed on the second baffle plate 30, etc.

During a winding process, two conduction pins 40 of the plurality of the conduction pins are connected to one of the wire winding pins 51 via two wires respectively, and the two wires fixed on the one of the wire winding pins are electrically connected together.

Accordingly, two windings are connected in series by connecting to the wire winding pin, and the wire winding pin could be used as a tap, such that different voltages may be provided. Moreover, during winding process, the wire may be wound around the main body by a winding machine after fixed to the conduction pins, and finally fixed to the wire winding pin, thereby realizing fast and automatic winding, reducing manual operations and manufacturing costs, and improving stability. In addition, the wire winding pin and the conduction pins are respectively disposed on the first baffle plate and the second baffle plate, therefore more kinds of arrangements can be provided depending on needs without being limited to few arrangement of connecting to conduction pin at the bottom.

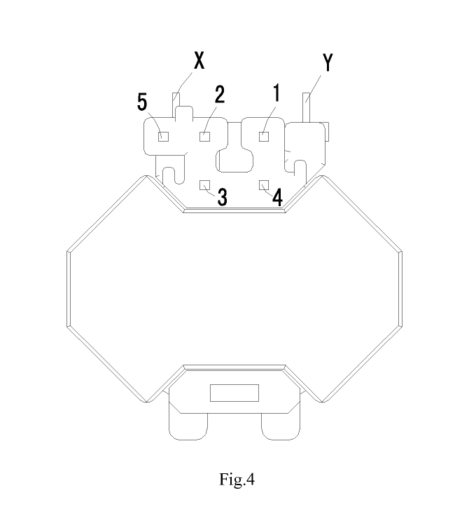

One embodiment of the present disclosure may be applied to a bobbin having four or more conduction pins. For example, the number of the conduction pins may be more than four, and the number of the wire winding pin may be more than two, but the invention is not limited thereto. As shown in FIG. 4, four conduction pins 40 may be arranged in rectangular, the rest conduction pins may be distributed at the periphery of the four conduction pins 40.

With reference to FIG. 4, in the present embodiment, there are five conduction pins, which are numbered with reference numerals 1-5 respectively. Four of the conduction pins numbered with reference numerals 1-4 are arranged in rectangular on one plane. As shown in FIG. 4, the conduction pins 3 and 4 are near the main body, and the conduction pins 1 and 2 are located away from the main body. The conduction pin 5 is located in line with and away from the conduction pins 1 and 2. In the present embodiment, there are two wire winding pins 51 which are numbered with X and Y respectively. But the invention is not limited thereto.

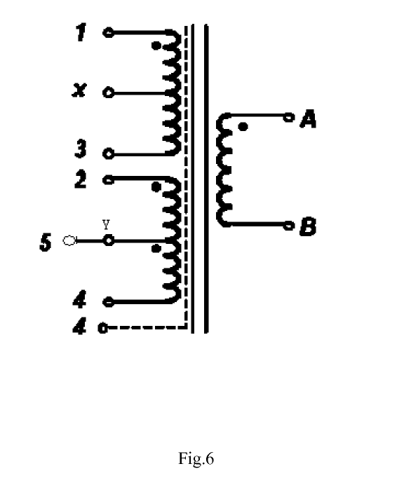

With reference to FIGS. 4 and 6, a wire winding method applying the bobbin of the first embodiment will be described in detail. As described here, in one embodiment, the method may comprises:

Connecting the conduction pins 1 and 3 to the wire winding pin X via wires respectively;

Connecting the conduction pins 2 and 4 to the wire winding pin Y via wires respectively; and

Electrically connecting the wire winding pin X and/or the wire winding pin Y to the conduction pin 5 via a wire.

In the present embodiment, the conduction pin 5 and the wire winding pin Y are electrically connected together which are arranged in a diagonal position. The present disclosure is not limited thereto. For example, various options for choosing conduction pins are possible.

FIG. 6 is a schematic view as a result of winding wires around the bobbin according to the first embodiment of the disclosure. Two windings connected in series may be provided by tapping of the wire winding pin X with the conduction pins 1 and 3. Two windings connected in series may be provided by tapping of the wire winding pin Y with the conduction pins 2 and 4. Moreover, the wire winding pin Y may be connected to the conduction pin 5 via a wire. Therefore, by way of connecting the wire winding pins X, Y and the conduction pins, each of the conduction pins could be utilized to the limit so that the function of the bobbin may be improved. In addition, the wire winding pins and the conduction pins may be respectively disposed on the first baffle plate and the second baffle plate located up and down, therefore it is possible to select the conduction pin or wire winding pin at a suitable position to connect to the circuit board depending on needs without being limited to the conduction pin at the bottom of the bobbin.

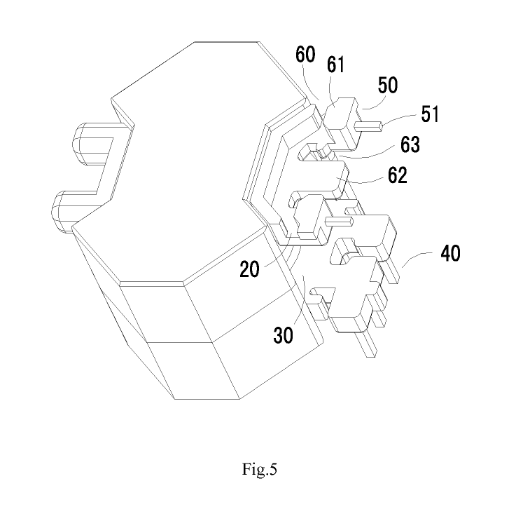

With reference to FIG. 5, the wire winding pin 51 is radially protruded from the first baffle plate 20 and perpendicular to the conduction pin 40 so that it is easy to wind wire between the wire winding pin 51 and the conduction pin 40, avoiding short circuit and facilitated connecting the wire winding pin with other structures, but the invention is not limited thereto.

Optionally, the bobbin may further comprise a guide portion 60. In the present embodiment, the guide portion 60 may be formed on the first baffle plate 20. The guide portion 60 comprises at least one guiding pin 61 radially protruded from the first baffle plate 20, and the wire winding pin 51 may partially embedded in the guiding pin 61 and extend outward in a radial direction. However the present disclosure is not limited thereto. The present embodiment is described with the example that the number of guiding pins 61 is two, as can be seen in FIG. 5, but the invention is not limited thereto. During winding process, winding the first end of the wire around the guiding pin 61 before winding the wire around the main body, and removing the first end of the wire from the guiding pin 61 after the wire has been wired around the main body and the second end of the wire has connected to the conduction pin 40. Therefore, during winding process, the guiding pin 61 may help hold part of the wire temporarily thereby reducing labor, and realizing automation wire winding during the whole winding process, but the invention is not limited thereto.

With reference to FIG. 5, the guide portion 60 may further comprise a separator 62. The separator 62 may fix at the first baffle plate 20 and be radially protruded from the first baffle plate 20. The separator 62 may be arranged distanced from and between adjacent guiding pins 61. A notch 63 is formed between each guiding pin 61 and the separator 62, through which the wire passes and then is wound around the guiding pin 61 temporarily, such that the wire can be firmly attached to the guide portion 60.

Optionally, the main body 10, the first baffle plate 20, the second baffle plate 30 and the guide portion 60 may be made of insulation material, and the wire winding pin 51 may be made of conduction material.

It should be understood that the position of the guide portion 60 is not limited thereto. The guide portion 60 may be disposed on the second baffle plate 30. A plurality of guide portions 60 may also be disposed on the first baffle plate 20 and the second baffle plate 30.

Further, the separator may also be located between the two wire winding pins.

### Second Embodiment of a Bobbin

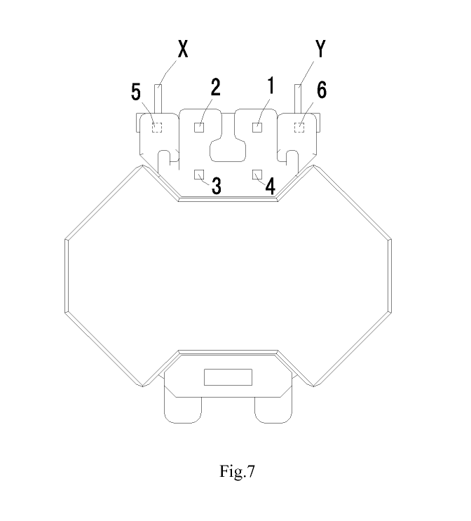

With reference to FIG. 7, the bobbin of the second embodiment differs from the first embodiment in that, there are six conduction pins 40, which are numbered with reference numerals 1-6 respectively, and the number of the wire winding pins is two. Four of the conduction pins numbered with reference numerals 1-4 are arranged in rectangular on one plane, the conduction pins 3 and 4 are near the main body, and the conduction pins 1 and 2 are located away from the main body. The conduction pins 5 and 6 are located in line with and away from the conduction pins 1 and 2 respectively.

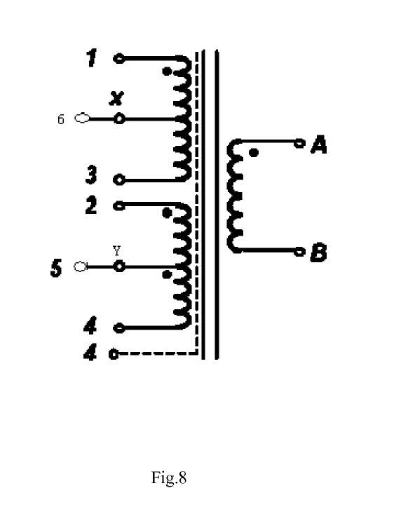

With reference to FIGS. 7 and 8, a wire winding method applying the present bobbin of the second embodiment will be described in detail. As described here, in one embodiment, the method may comprises:

Connecting the conduction pins 1 and 3 to the wire winding pin X via wires respectively;

Connecting the conduction pins 2 and 4 to the wire winding pin Y via wires respectively; and

Electrically connecting the wire winding pin X and Y to the conduction pins 5 and 6 via wires respectively.

In the present embodiment, the conduction pin 5 and the wire winding pin Y are electrically connected together which are arranged in a diagonal position. The conduction pin 6 and the wire winding pin X are electrically connected together which are arranged in a diagonal position, but the invention is not limited thereto.

Other parts of the second embodiment may be substantially the same as that of the first embodiment mentioned above and the detailed description is omitted herein.

### Embodiment of a Transformer

The bobbin of present disclosure may be applied to a transformer. The transformer comprises a bobbin, a magnetic core, and a winding portion.

With reference to FIGS. 1-6, the bobbin comprises a main body 10, a first baffle plate 20, a second baffle plate 30, a plurality of conduction pin 40 and an auxiliary wire winding portion 50. The main body 10 extends along an axis, within which a hollow may pass. The first baffle plate 20 and the second baffle plate are disposed on two ends of the main body 10 respectively. The plurality of conduction pins 40 are dispose on the second baffle plate 30. The auxiliary wire winding portion 50 is disposed on the first baffle plate 20 comprises at least one wire winding pin 51. The wire winding pin 51 connects to the first baffle plate 20 and electrically connects to the conduction pin 40.

The magnetic core may be disposed through the hollow. The winding portion is wound around the main body and comprises a first winding and a second winding.

The transformer having the bobbin of the first and second embodiment may include a plurality of independent first windings. The number of the wire winding pins may be not less than that of the first windings. For example, the number of the wire winding pin may be equal to that of the first winding.

As shown in FIG. 6, the number of the wire winding pin 51 is two, and the number of the conduction pin 40 is five. The transformer includes independent first windings formed with conduction pins 1 and 3 and conduction pins 2 and 4, respectively. The wire winding pin X may be used as a tap so that the winding formed with the conduction pins 1, 3 may be used as two windings connected in series. By connecting to the wire winding pin Y, the conduction pin 5 can be utilized for connecting other connectors to play an electrical function. But the invention is not limited thereto.

As shown in FIG. 8, the number of the wire winding pins 51 is two, and the number of the conduction pins 40 is six. The transformer includes independent first windings formed with conduction pins 1 and 3 and conduction pins 2 and 4, respectively. The wire winding pins X and Y can be electrically connected to the conduction pins 5 and 6 respectively. The transformer may have a first output end A and a second output end B.

It should be understood that all the bobbins with various modifications and alternative forms mentioned in the first and second embodiments may applicable to the transformer of the present disclosure, which fall within the scope of the claims of the present disclosure.

To sum up, in the embodiments of the present disclosure, the wire winding pin may not only form various windings by connecting with the conduction pin, but also may help each of the conduction pins to play its connection function. Consequently, the functionality of the transformer having the present bobbin could be enhanced, an automatic winding process for the bobbin may be able to be realized, thereby reducing manual operations and manufacturing costs, and improving stability. In addition, the wire winding pin and conduction pin may be respectively disposed on the first baffle plate and the second baffle plate located up and down, therefore more kinds of arrangements may be provided depending on needs without being limited to only one arrangement that connecting to conduction pin at the bottom.

### Embodiment of Method for Winding a Wire Around a Bobbin

A method for winding a wire around a bobbin according to one embodiment of the present disclosure comprises steps of:

Providing a bobbin which has a main body, an auxiliary wire winding portion and a plurality of conduction pins, the auxiliary wire winding portion comprises at least one wire winding pin;

Winding a wire around the main body to form a first winding;

Electrically connecting one end of the first winding with the at least one wire winding pin;

Winding a wire around the main body to form a second winding; and

Electrically connecting one end of the second winding with the at least one wire winding pin so as to electrically connect said end of the second winding with said end of the first winding.

In another embodiment, the method further comprises a step of:

Electrically connecting the at least one of the wire winding pin with the at least one of the conduction pin.

In another embodiment, the auxiliary wire winding portion further comprises at least one guiding pin protruded outward in a radial direction, the method further comprises steps of:

Winding a wire of a winding around the guiding pin; and

Removing the wire of the winding from the guiding pin. The winding may be the first or/and second winding, but the invention is not limited thereto.

In another embodiment, the wire of the winding is partially wound around the guiding pin. For the methods described herein, the sequence of the steps may vary.

The exemplary embodiments of the present disclosure have been illustrated and described above. It should be understood that, the present disclosure is not limited to the disclosed embodiments. On the contrary, the present disclosure intends to cover various modifications and equivalent arrangements within the spirit and the scope of the appended claims.

What is claimed is:

1. A bobbin, comprising:
a main body for winding a wire thereon;
a first baffle plate and a second baffle plate respectively disposed on both ends of the main body;
a plurality of conduction pins provided on the second baffle plate; and
an auxiliary wire winding portion comprising at least one wire winding pin for electrically connecting with at least one of the plurality of conduction pins.

2. The bobbin according to claim 1, wherein the wire winding pin is connected to the first baffle plate.

3. The bobbin according to claim 1, wherein the auxiliary wire winding portion further comprises at least one guiding pin protruded outward in a radial direction, and the guiding pin is made of insulation material and used for winding the wire thereon or removing the winding therefrom.

4. The bobbin according to claim 3, wherein the auxiliary wire winding portion comprises at least two the guiding pins and a separator located between the two guiding pins.

5. The bobbin according to claim 4, wherein the auxiliary wire winding portion comprises at least one notch located between the separator and the guiding pins.

6. The bobbin according to claim 3, wherein the at least one wire winding pin is disposed on the guiding pin and extending outward in the radial direction.

7. The bobbin according to claim 1, wherein at least a part of the wire winding pin is conductive.

8. The bobbin according to claim 1, further comprising a conductor for electrically connecting at least one of the wire winding pins with at least one of the conduction pins.

9. The bobbin according to claim 1, wherein the auxiliary wire winding portion comprises at least two wire winding pins and a separator located between the two wire winding pins.

10. A transformer, comprising:
a bobbin;
a magnetic core; and
a winding portion comprising at least one first winding and at least one second winding;
wherein the bobbin comprising:
a main body for winding the winding portion thereon;
a first baffle plate and a second baffle plate respectively disposed on both ends of the main body;
a plurality of conduction pins provided on the second baffle plate; and
an auxiliary wire winding portion comprising at least one wire winding pin for electrically connecting with at least one of the plurality of conduction pins.

11. The transformer according to claim 10, wherein the at least one wire winding pin is connected to the first baffle plate.

12. The transformer according to claim 10, wherein the auxiliary wire winding portion further comprises at least one guiding pin protruded outward in a radial direction, and the guiding pin is made of insulation material and used for winding at least a part of the winding portion thereon or removing at least a part of the winding portion therefrom.

13. The transformer according to claim 12, wherein the at least one wire winding pin is disposed on the guiding pin and extending outward in the radial direction.

14. The transformer according to claim 12, wherein the auxiliary wire winding portion comprises at least two the guiding pins and a separator located between the two guiding pins.

15. The transformer according to claim 14, wherein the auxiliary wire winding portion comprises at least one notch located between the separator and the guiding pins.

16. The transformer according to claim 10, wherein the auxiliary wire winding portion comprises at least two the wire winding pins and a separator located between the two wire winding pins.

17. A method for winding a wire around a bobbin, comprising:
providing a bobbin having a main body, an auxiliary wire winding portion and a plurality of conduction pins, the auxiliary wire winding portion comprising at least one wire winding pin;
winding a wire around the main body to form a first winding;
electrically connecting one end of the first winding with at least one wire winding pin;
winding a wire around the main body to form a second winding; and
electrically connecting one end of the second winding with the at least one wire winding pin so as to electrically connect said end of the second winding with said end of the first winding member.

18. The method according to claim 17, further comprising:
electrically connecting at least one wire winding pin with at least one conduction pin.

19. The method according to claim 17, wherein the auxiliary wire winding portion further comprises at least one guiding pin protruded outward in a radial direction, the method further comprises:
winding a wire of a winding around the guiding pin; and
removing the wire of the winding from the guiding pin.

20. The method according to claim 19, wherein, the wire of the winding is partially wound around the guiding pin.
